(19) United States
(12) Patent Application Publication
(10) Pub. No.: US 2025/0222534 A1
(43) Pub. Date: Jul. 10, 2025

(54) Method and Joining System for Producing a Structural Component, Computer Program Product and Computer-Readable Storage Medium

(71) Applicant: Bayerische Motoren Werke Aktiengesellschaft, Muenchen (DE)

(72) Inventors: Stefanus BOSCH, Holzkirchen (DE); Thiemo FIEGER, Olching (DE); Ruediger FRIEMEL, Schwabhausen (DE); Felix HAECKEL, Muenchen (DE); Nicolai SKRYNECKI, Grosskarolinenfeld (DE)

(21) Appl. No.: 18/855,676

(22) PCT Filed: Jun. 28, 2023
(86) PCT No.: PCT/EP2023/067583

§ 371 Date: Oct. 10, 2024

(30) Foreign Application Priority Data
Jul. 4, 2022 (DE) 10 2022 116 625.2

(51) Int. Cl. B23K 9/04; B33Y 10/00; B33Y 30/00

(52) U.S. Cl. CPC B23K 9/044; B33Y 10/00; B33Y 30/00

(57) ABSTRACT

A method for producing a structural component is provided. The structural component is formed by a base element. The method includes providing at least one insert part as part of the base element, and geometrically widening the at least one insert part to form the base element with the layered construction of at least one remaining element section on the at least one insert part by way of wire-based welding.

### BACKGROUND AND SUMMARY

The invention relates to a method and to a joining system for producing a structural component, and to a computer program product and to a computer-readable storage medium on which a computer program product is stored for producing a structural component, in particular for a motor vehicle.

Additive manufacturing methods for the layered construction of structural components are known in principle from the prior art. These include, for example, laser sintering, laser beam melting, or 3D printing. Structural components can be generatively constructed by way of these methods. In this context, additive manufacturing methods offer a high degree of flexibility in terms of the component geometries. However, these methods tend to be slow, so that very much longer manufacturing times have to be taken into account for the production of a structural component than when using a casting method or sheet metal forming method, for example. Therefore, additive manufacturing methods to date have been economical only in the case of low production volumes. Moreover, additively manufactured structural components have anisotropic mechanical properties, for example, which represent a challenge when the structural components are to meet the mechanical requirements set for them.

Furthermore, a combined method in which, for producing a structural component, initially a first base body is constructed layer-by-layer, a supplementary profile is then positioned on the first base body and fastened thereto in a materially integral manner, and subsequently a second base body for refining the first base body is constructed layer-by-layer, is described in the not previously published German patent application 10 2022 105 591.4. The supplementary profile is correspondingly prefabricated so as to provide a fastening point for fastening further components or attachment parts.

Against this background, it is an object of the invention to specify a possibility pertaining to how a high degree of flexibility in terms of modifications to the component can be achieved in association with low production costs in manufacturing a structural component.

The object is achieved by a method, a joining system, a computer program product, and a computer-readable storage medium according to the claimed invention. Further advantageous embodiments are derived from the the description hereunder.

Specified is a method for producing a structural component, wherein the structural component is formed by a main body. The method comprises the following steps:
providing at least one insert part as part of the main body; and
geometrically extending the at least one insert part to form the main body by the layered construction of at least one balance body portion on the at least one insert part by way of wire-based welding.

The main body substantially defines the geometric dimensions of the structural component and represents the functionality of the structural component. Provided according to embodiments of the invention is a hybrid main body which contains, or is composed of, at least one insert part as well as at least one balance body portion of a layered construction. Insert part(s) and balance body portion(s) conjointly form the main body. The balance body portion is in particular not an additional structure which is subsequently applied to an already existing main body in order to influence the mechanical properties of the main body; instead, the balance body portion is an essential constituent part of the main body. The main body can have one, or more than one, insert part. Likewise, the main body can have only one balance body portion, or more than one balance body portion. The main body is completed only when combined with insert part(s) with balance body portion(s), the structural component thus obtaining its substantial geometric dimensions.

The at least one balance body portion is constructed by wire-based welding. Particularly short manufacturing times can be achieved by this method. The at least one balance body portion is constructed on the insert part and in the process connected to the latter in a materially integral manner. In this way, the insert part is preferably provided first and, proceeding therefrom, the balance body portion is integrally molded thereon. Owing to this fact, the requirement of providing a base plate for constructing the structural component can be dispensed with, for example. Adhering to the necessary manufacturing tolerances becomes easier when the structural component is constructed while proceeding from an already existing insert part with defined dimensions. Furthermore, by using one or a plurality of insert parts, the proportion on the main body that is generated by additive manufacturing is reduced, as a result of which the manufacturing time can be reduced and the manufacturing costs can be lowered. In the context of the present invention it has been recognized that, by combining a wire-based additive manufacturing method with already prefabricated insert parts, the advantages of both methods can be optimally combined. This means specifically that the cost advantages of conventional manufacturing methods, such as, for example, casting methods or sheet-metal forming methods, are combined with the advantages of additive manufacturing in terms of high flexibility in the design of the components, low costs and rapid ability to implement modifications to components. With the hybrid construction of the main body according to embodiments of the invention, the invention departs from the previously customary assumption that structural components should be of a monolithic construction, at least if the type of material should be consistent.

The insert part can be a sheet-metal component or a more solid formed component such as, for example, a cast component or an extruded component.

The insert part preferably has a simple geometric shape. The insert parts in the structural component preferably form component portions which have a simple geometric shape. In this context, a simple geometric shape is understood to mean in particular a three-dimensional shape of which the external surface is designed as a ruled surface. In the case of a ruled surface, a straight line which is completely contained in the surface can be placed through each point of the surface. Owing to the fact that portions of the structural component that have a simple geometric shape are formed by prefabricated insert parts, it is achieved that the additive manufacturing is restricted to geometrically complex component portions, which is associated with advantages in terms of costs and time.

In one preferred design embodiment, at least one insert part with a simple geometric shape is provided in the form of a full section or hollow section. The section herein can have arbitrary cross sections. The section body preferably has a consistent cross section along its longitudinal extent. Insert parts of this type can be manufactured in a cost-effective manner in large volumes, for example by extrusion methods. Additionally, the additive manufacturing is restricted to geometrically complex component portions, which is associated with further advantages in terms of costs and time.

In one design embodiment it is particularly preferable when the balance body portion(s) is/are generated by way of WAAM or laser DED. In wire arc additive manufacturing (WAAM), a metal wire is melted while using an electric arc and, for example by way of a multi-axis manipulator, is applied layer-by-layer in the desired shape to the component. The laser direct energy deposition method (laser DED) is performed in a similar manner but the wire is melted by way of laser radiation. Both methods are distinguished by very high application rates and a high degree of flexibility in terms of the geometries that can be applied. Moreover, components with a very high degree of ductility can be constructed by this method when using a corresponding wire material.

In one preferred design embodiment it is provided that at least one balance body portion and at least one insert part conjointly represent a load path in the main body. The insert part can be incorporated into the load path in that, for example, the at least one insert part is attached to balance body portions on two mutually opposite sides. The insert part can also connect one or more balance body portion(s), for example a plurality of sections, to one another in the manner of a skeleton structure. Insert part(s) and balance body part(s) can preferably be disposed behind one another in the direction of extent of the load path. A design embodiment of this type enables the cost-effective and rapid production of mechanically highly stable structural components.

Likewise, it is also possible that a load path or a main load path runs only through one or a plurality of balance body portion(s), and the insert parts are not incorporated into this load path.

The structural component is, for example, a bodywork component of a motor vehicle, and preferably is a vehicle rear, a vehicle side panel or a vehicle front. The structural component can be, for example, a chassis frame component of a motor vehicle, such as a subframe, for example.

Furthermore specified is a joining system for producing a structural component, wherein the structural component is formed by a main body. The joining system contains an automated positioning device which is specified to position at least one insert part in a predefined position, and an automated, wire-based welding device which is specified to geometrically extend the at least one insert part to form the main body by the layered construction of at least one balance body portion on the at least one insert part. The joining system is particularly suitable for carrying out the method described above. The joining system achieves the same technical effects as the method described above. The automated positioning device can be, for example, a programmable industrial robot. The wire-based welding device can preferably be assembled on an industrial robot and be moved by the latter for the layered construction of the balance body portions. A control apparatus, for example a computer, by way of which the positioning device and the welding device are operated, can be provided.

Furthermore specified is a computer program product which contains commands that, when executing the computer program product by a computer, initiate the latter to carry out a method as described above for producing a structural component by a joining system as described above. For this purpose, the computer can be operatively connected to one or a plurality of industrial robots and a WAAM welding device, and control those in order to carry out the method.

Furthermore specified is a computer-readable, preferably non-volatile storage medium on which the computer program product described above is stored.

The computer program product can be implemented as a computer-readable instruction code in any suitable programming language and/or machine language. The computer program product can be stored on a computer-readable storage medium such as, for example, a removable drive, a data disk, or a fixedly installed drive. The instruction code programs a computer or other programmable apparatuses such as, for example, a control apparatus, in such a manner that the desired functions are carried out. Furthermore, the computer program product can be provided in a network such as, for example, a local area network or the internet. The computer program product can be implemented by way of software as well as by way of hardware, for example in the form of special electronic circuits, or in a hybrid construction mode.

The computer program product as well as the computer-readable storage medium herein achieve the same advantages as have been described in the context of the method.

Further advantages, features and details of the invention are derived from the description hereunder, in which exemplary embodiments of the invention are described in detail with reference to the drawings. The features mentioned in the claims and in the description can in each case be relevant to the invention individually or in any arbitrary combination. Should the term “can” be used in this application, this refers to the technical possibility as well as to the actual technical implementation.

Exemplary embodiments are explained by way of the appended drawings hereunder.

### BRIEF DESCRIPTION OF THE DRAWINGS

FIG. 1 shows an exemplary structural component.

FIG. 2 shows a schematic method sequence for producing the structural component.

FIG. 3 shows an exemplary storage medium having a computer program product stored thereon.

### DETAILED DESCRIPTION OF THE DRAWINGS

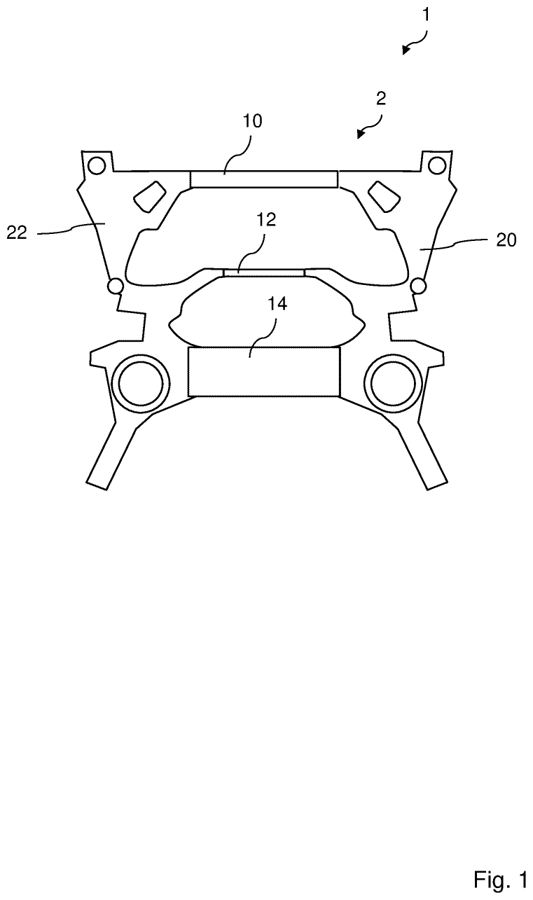

FIG. 1 shows an exemplary structural component 1 which is able to be produced by the method according to embodiments of the invention. The structural component 1 is a front subframe of a motor vehicle. The structural component 1 contains three insert parts 10, 12 and 14 which are provided in the form of sections. Two balance body portions 20, 22 are integrally molded on the insect parts 10, 12 and 14 by way of wire-based welding, for example by way of WAAM or laser DED. The balance body portions 20, 22 are constructed layer-by-layer from a molten wire material and in the process connected to the insert parts 10, 12 14 in a materially integral manner. The insert parts 10, 12 and 14 and the two balance body portions 20, 22 conjointly form the main body 2 of the structural component.

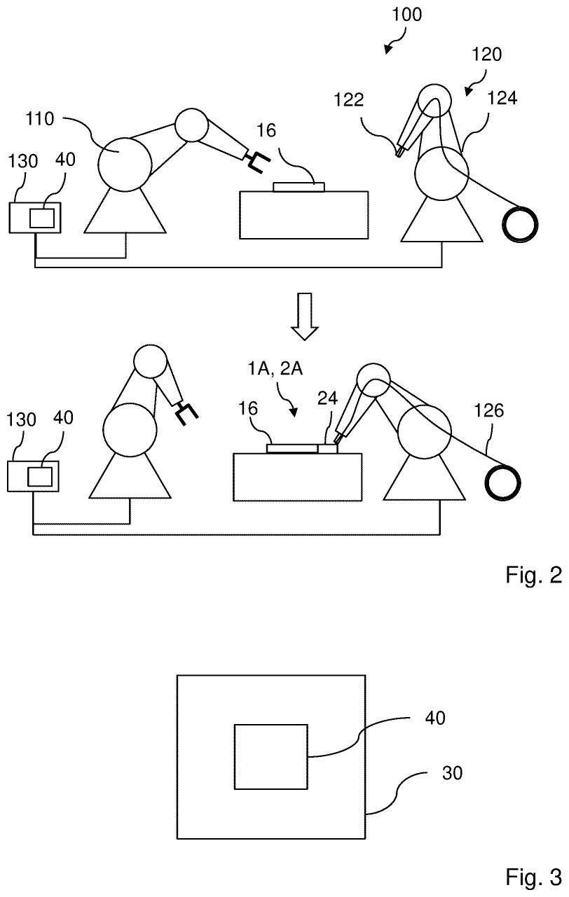

FIG. 2 shows an exemplary method sequence for producing a structural component 1A by an exemplary joining system 100. The structural component 1A is a bodywork component, for example. The joining system 100 has an automated positioning device 110 in the form of an industrial robot, and an automated, wire-based welding device 120 having a WAAM welding unit 122 which is disposed on an industrial robot 124 and displaceable by the latter. The positioning device 110 and the welding device 120 are operatively connected to a control apparatus 130 which is specified to control the positioning device 110 and the welding device 120. A corresponding computer program product 40 for carrying out the control commands required for this purpose is installed in the control apparatus 130.

For carrying out the method, at least one insert part 16 is first provided by the positioning device 110. Subsequently, at least one balance body portion 24 is integrally molded on the insert part 16 by way of the welding device 120. For this purpose, a wire material 126 is molten and constructed layer-by-layer so as to form the balance body portion 24, wherein the latter is connected to the insert part 16 in a materially integral manner. Balance body portion 24 and insert parts 16 conjointly form a main body 2A, the latter forming the structural component 1A.

Only one insert part 16 and one balance body portion 24 are illustrated in FIG. 2. Nevertheless, the structural component illustrated in FIG. 1, or any other structural component having one or more insert parts and one or a plurality of body portions, can also be produced by the method.

FIG. 3 shows a computer-readable and non-volatile storage medium 30 having a computer program product 40 stored thereon. The computer program product 40 comprises commands that, when executing the computer program product by a computer, initiate the latter to carry out the method described for producing the structural component by a suitable joining system such as, for example, the joining system 100 from FIG. 2.

### LIST OF REFERENCE SIGNS

1, 1A Structural component
2, 2A Main body
10, 12, 14, 16 Insert parts
20, 22, 24 Balance body portion
30 Computer-readable storage medium
40 Computer program product
100 Joining system
110 Positioning device
120 Welding device
122 WAAM welding unit
124 Industrial robot
126 Wire material
130 Control apparatus

1.-12. (canceled)

13. A method for producing a structural component, wherein the structural component is formed by a main body, the method comprising:
providing at least one insert part as part of the main body; and
geometrically extending the at least one insert part to form the main body by layered construction of at least one balance body portion on the at least one insert part by way of wire-based welding.

14. The method according to claim 13, wherein the at least one insert part is a sheet-metal component, a cast component, or an extruded component.

15. The method according to claim 13, wherein the at least one insert part has a geometrically simple shape.

16. The method according to claim 15, wherein the at least one insert part is configured as a full section or a hollow section.

17. The method according to claim 13, wherein the at least one balance body portion is generated by way of wire arc additive manufacturing (WAAM) or laser direct energy deposition (DED).

18. The method according to claim 13, wherein at least one balance body portion and at least one insert part conjointly represent a load path in the main body.

19. The method according to claim 13, wherein the structural component is a bodywork component of a motor vehicle.

20. The method according to claim 19, wherein the structural component is a vehicle rear, a vehicle side panel or a vehicle front.

21. The method according to claim 13, wherein the structural component is a chassis frame component of a motor vehicle.

22. The method according to claim 21, wherein the structural component is a subframe.

23. A joining system for producing a structural component, wherein the structural component is formed by a main body, the joining system comprising:
an automated positioning device which is configured to position at least one insert part in a predefined position; and
an automated, wire-based welding device which is configured to geometrically extend the at least one insert part to form the main body by layered construction of at least one balance body portion on the at least one insert part.

24. The joining system according to claim 23, wherein the joining system is configured to carry out a method comprising:
providing the at least one insert part as part of the main body; and
geometrically extending the at least one insert part to form the main body by the layered construction of the at least one balance body portion on the at least one insert part by way of wire-based welding.

25. A computer product comprising a non-transitory computer-readable medium having stored thereon program code which, when executed on a processor, carries out the method according to claim 13.
